(19) United States
(12) Patent Application Publication
(10) Pub. No.: US 2008/0102269 A1
(43) Pub. Date: May 1, 2008

(54) Multilayered Effect Pigment Comprising a Central Absorber Layer, Method for the Production Thereof, Use of the Same, Coating Agent and Coated Object

(76) Inventors: Wolfgang Herzing, Speikern (DE); Martin Fischer, Neuhaus (DE); Bernhard Geissler, Schwarzenbruck (DE); Thomas Schuster, Lauf (DE)

Correspondence Address: OSTROLENK FABER GERB & SOFFEN, 1180 AVENUE OF THE AMERICAS, NEW YORK, NY, 100368403, US

(21) Appl. No.: 11/722,733

(22) PCT Filed: Dec. 19, 2005
(86) PCT No.: PCT/EP05/13649

§ 371 Date: Aug. 22, 2007

(30) Foreign Application Priority Data
Dec. 23, 2004 (DE) 10 2004 063 433.5

(51) Int. Cl. B32B 9/00; C04B 14/00

(52) U.S. Cl. 428/336; 427/419.1

(57) ABSTRACT

The invention relates to a multilayered PVD effect pigment in which the PVD effect pigment comprises the following layer sequence: (a) a dielectric layer having a geometrical thickness of from 25 nm to not more than 180 nm, (b) a metallic absorptive layer having a geometrical thickness of not more than 35 nm, (c) a dielectric layer having a geometrical thickness of from 25 nm to not more than 180 nm, wherein the layers adjoin each other directly and the dielectric layers (a) and (c) are the same or different. The invention also relates to methods for the manufacture of said multilayered effect pigment and to the use of the multilayered effect pigment.

The present invention relates to colored effect pigments with a metallic luster having a central absorptive layer and to methods for the production thereof. The invention also relates to the use of said effect pigments, to a coating composition, and to coated articles.

Multi-layered effect pigments produced by the PVD (physical vapor deposition) process are disclosed in, eg, U.S. Pat. No. 3,438,796. U.S. Pat. No. 3,438,796 discloses five-layered interference pigments with a central reflecting layer of aluminum flanked on both sides by a layer of SiO₂ having a film thickness of from 100 to 600 nm and finally by a semi-transparent absorptive layer of aluminum on each side. The central aluminum layer is opaque due to its layer thickness of more than 60 nm and has reflecting properties. The outer absorptive layers of aluminum have thicknesses of less than 40 nm. The effect pigments disclosed in U.S. Pat. No. 3,438,796 have a strong color flop, ie a color impression that greatly depends on the viewing angle.

U.S. Pat. No. 5,571,624 discloses an enamel containing multi-colored interference pigments. These interference pigments have a central metallic, reflecting layer flanked on both sides by layer packages of a dielectric and a semi-opaque metal layer, said dielectric layer facing toward the reflector core. The dielectric layers have at least an optical layer thickness of two fourths of a selected wavelength of 400 nm. This corresponds, for example, for an SiO₂ layer having a refractive index of 1.55, to a geometrical minimal layer thickness of 310 nm. The effect pigments disclosed by U.S. Pat. No. 5,571,624 also have a strong color flop and relatively high pigment layer thicknesses.

U.S. Pat No. 6,246,523 describes the production of multi-layered pigments with color shade shifting properties. These multi-layered pigments may have a layer structure in which metallic absorptive layers are applied to both sides of a dielectric layer. A special feature of these optically variable pigments of, say, the “Chromaflair” type supplied by Flex Products, Inc. is, besides a very strong color flop, an extremely high particle thickness of about 1 μm. Because of these high particle thicknesses such pigments are unsuitable for certain applications, eg, in the printing industry and various enamel applications. Another disadvantage is that these multi-layered pigments having a very strong color flop have high film thicknesses.

EP 0 472 371 A1 describes an optically variable layer structure leading to interference pigments having purer color shades by suppression of certain interference peaks. These interference pigments have a complicated asymmetrical layer structure. An outer layer consists of an opaque metallic reflector on which at least two layer packages, each consisting of a dielectric layer and a metallic absorptive layer, are disposed.

A five-layered pigment structure with a central opaque reflector layer is also described in WO 00/34395.

WO 99/35194 describes a bright metal pigment having a central opaque metal layer and a three-layered structure that is also produced by PVD processes.

Effect pigments having an opaque core of aluminum are available on the market, inter alia, under the trade names Variocrom® and are supplied by BASF AG. Here, first of all, a thick, low-refracting SiO₂ layer is deposited by the wet-chemical sol-gel procedure on to aluminum pigments, and subsequently an iron oxide layer is applied to the aluminum pigments doped with SiO₂ from iron pentacarbonyl in a fluidized bed process. The aluminum core in this case serves as reflective material and, as a fully opaque material, increases the covering power substantially, compared with transparent pearl-luster pigments. The SiO₂ layer serves as a low-refraction interference buffer. “Magic Red™” and “Magic Gold™”—products now on the market—have SiO₂-layer thicknesses of from 320 to approximately 400 nm. The layers are applied as homogenously as possible for optical reasons in order to permit strong interference effects. This leads to effect pigments having strong color flops going into the complementary color range. Such strong effects, however, are not always desirable and are regarded in many applications as being too “loud.”

Multi-layered optically variable effect pigments having a strong color flop have been described in great variety in the prior art. A common feature of all interference pigments described hitherto is always a central opaque metallic reflective layer. The reflective layer has at least a layer thickness such that it is opaque for visible light and therefore causes maximal reflection of incident light corresponding to the nature of the metal used.

In the known optically variable effect pigments the thickness of the dielectric layer is adjusted such that interference phenomena of the second or higher order are manifested since they are more intense and of purer color than those of the first order.

A disadvantage of such interference pigments is the fact that for achieving the interference phenomena, always only the one side is available for direct interference effects, for example, in an application medium, eg an enamel film applied to a substrate surface, the side which is uppermost following the plane-parallel alignment of the effect pigments, ie the side remote from the substrate surface, ie, the side of the interference pigment facing the incident light. The bottommost side of the interference pigments is not involved in the optical effect since the central metal layer is opaque and accordingly does not transmit light but totally reflects it. The bottommost side of the interference pigments can only become optically active by secondary effects such as by reflection on several effect pigments layered one upon the other in the application medium.

The interference pigments known hitherto are thus unnecessarily thick since the lower side of the pigments cannot be utilized for the primary interference phenomena. This is also of disadvantage in view of the high costs of PVD processes since here a lot of material is wasted.

The total thickness of the effect pigments known hitherto also leads to a low, ie unfavorable, form factor. The form factor is defined as the ratio of the length of the particles to their thickness. A low form factor impairs the orientation of the effect pigment essential for the visual impression observed by a viewer, ie their desirable plane-parallel alignment in the application medium, relative to the substrate surface. An impaired orientation of the effect pigments in the application medium leads to an impairment of the optical properties of the effect pigments in the application medium, eg, in an enamel film.

WO 2004/052999 describes coated effect pigments having a central aluminum layer with a layer thickness of from 10 to 100 nm and an SiO₂ coating having a layer thickness of from 200 to 500 nm. The disadvantage is that the pigments disclosed in WO 2004/052999 showing color flop have a significant total pigment thickness, and their production is therefore proportionately expensive.

There is therefore a demand for effect pigments showing color flop that do not have the above-mentioned drawbacks. A need also exists for optically high-quality, essentially single-color metallic effect pigments that have no, or substantial no, color flop. There is also a demand for optically high-quality metallic effect pigments having a gray or black appearance without color and without color flop.

It is also desirable to find a method for the production of such effect pigments.

The object of the invention is achieved by the provision of a multi-layered PVD effect pigment, said multi-layered PVD effect pigment having the following sequence of layers:
(a) a dielectric layer of a geometrical thickness of from 25 to not more than 180 nm,
(b) a metallic layer having a geometrical thickness of not more than 35 nm,
(c) a dielectric layer having a geometrical thickness of from 25 to not more than 180 nm,
   where said layers follow one another directly, and the dielectric layers (a) and (c) are the same or different.

Preferred variants are defined in the subordinate claims.

The present invention relates to multi-layered effect pigments having a central absorptive layer with semi-transparent properties.

For the purposes of the invention, effect pigments are pigments which are of platelet configuration so that in an application medium, such as an enamel, a paint, cosmetics, etc. they act as a large number of small, partially transparent mirrors and are oriented/aligned in an excellent manner in the application medium. The effect pigments are thus not spherical but rather of a flattened shape. The light reflected on the various layers of the layer structure of the effect pigments of the invention is reflected in a certain direction due to the flat structure of the effect pigments. In order to impart a pleasant visual impression to a viewer, it is essential that the pigments be aligned roughly plane-parallel to the substrate surface so that incident light is directionally reflected from all pigments, ie not scattered in a great variety of directions. In the case of an at least five-layer structure of the effect pigments of the invention, overlapping of the reflected light can cause interference effects that can be perceived by a viewer.

The metallic absorptive layer (b) is not opaque but rather partially transparent, the part of the incident light transmitted through the metallic layer being preferably less than 70%, more preferably less than 50% and even more preferably less than 30%, in all cases based on the incident light. The part of the incident light transmitted by the absorptive layer amounts to at least 10% and preferably at least 15%, based in each case on the incident light.

In each individual case, the degree of transmission depends on the nature of the absorptive layer and its layer thickness. The values pertain to average values of the transmission over the wavelength range of from 400 to 800 nm of the incident light.

The term “central absorptive layer” means, for the purposes of the invention, that the metallic absorptive layer is disposed within the pigment of the invention. The layer structure of the entire pigment can be symmetrical or asymmetrical relative to the position of the metallic absorptive layer. The layer structure is preferably symmetrical relative to the position of the metallic absorptive layer.

Metal films below a geometrical layer thickness of less than 40 nm lose their high degree of reflection, but because of their extremely high absorption of electromagnetic waves they still remain strong absorbers in the visible wavelength range. In the case of very thin layers, the metal films appear gray to black to a viewer. The multi-layered interference pigments of the invention possess central metallic absorptive layers having geometrical layer thickness of not more than 35 nm. According to another preferred embodiment, the metallic absorptive layer has a geometrical thickness of not more than 30 nm and more preferably from 2 to 20 nm. Below a layer thickness of 2 nm, the metal layers are too thin. In such a case the transparency of the metal layer is too high. In addition, the effect pigments are very difficult to stabilize mechanically at a layer thickness of less than 2 nm. Furthermore, pigments with a layer thickness of the metallic absorptive layer of less than 2 nm cannot be produced with reproducible optical quality.

Aluminum, silver, copper, gold, chromium, iron, titanium, platinum, palladium, nickel, cobalt, niobium, tin, zinc, rhodium, mixtures, alloys and combinations thereof are preferably used as metals for the metallic absorptive layer. Aluminum, silver, copper, gold, chromium, iron, titanium, mixtures, alloys and combinations thereof are preferably used.

The term “combinations of metal layers” means, for the purposes of the invention, two, three, four or more consecutive metal layers, in each case preferably discrete. The total layer thickness of these successive layers, however, must be under 40 nm to ensure partial transparency of the layer structure.

The term “mixtures” means, for the purposes of the invention, that the metals are applied jointly but do not form an alloy due to a thermodynamic mixing gap.

According to the invention alloys of two, three, four or more metals are preferably used which show appropriate thermodynamic stability.

The central absorptive layer is provided on both sides with a dielectric layer having a geometrical thickness of from 25 to not more than 180 nm in each case. As a dielectric, use will preferably be made of metal fluorides, metal oxides, metal sulfides, metal nitrides, metal carbides, and mixtures and combinations thereof. Metal oxides are particularly preferred in this case. The dielectric also preferably includes SiO₂, SiOₓ, where x is from 1.5 to 2, Al₂O₃, B₂O₃, TiO₂, ZrO₂, MgF₂ as well as their combinations or mixtures. The dielectric preferably consists of the aforementioned materials. In the case of SiOₓ, x is preferably from 1.7 to 2 and more preferably from 1.95 to 2. The numerical value of x may be a discrete number or a range, eg from 1.95 to 2. This can be measured, for example, by EDX analyses (EDX: elemental detection by x-ray analysis).

The dielectric layers preferably display in each case a geometrical layer thickness of not more than 150 nm. According to another preferred development, the thickness of the dielectric layer is in a range of from 30 nm to not more than 100 nm in each case.

According to another preferred embodiment, the dielectric layers disposed on both sides of the metallic absorptive layer are provided with a semi-transparent layer so that the following layer structure results:
(d) a semi-transparent layer,
(a) a dielectric layer,
(b) a metallic absorptive layer,
(c) a dielectric layer,
(e) a semi-transparent layer,
   where the semi-transparent layers (d) and (e) are applied directly to the dielectric layers (a) and (c) and are the same or different.

According to a preferred development of the invention, the semi-transparent layers (d) and (e) have a refractive index of more than 2.2. The semi-transparent layers (d) and (e) preferably comprise or consist of metal. According to another preferred embodiment, the semi-transparent layers (d) and (e) consist of the same materials as the aforementioned central metallic absorptive layer.

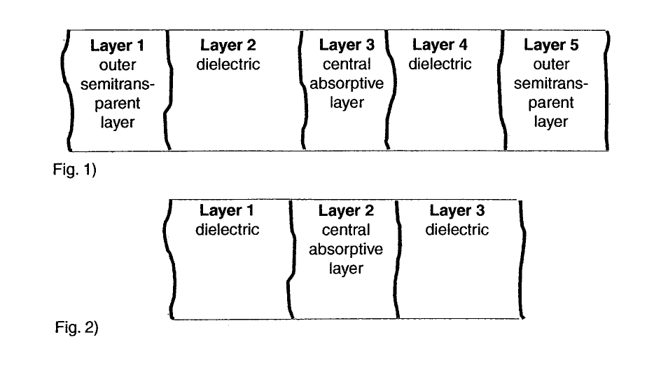

Each of the layers of the multi-layered interference pigment contributes to the creation of color. The color of the interference pigment can be adjusted via the number of layers as well as by the layer thicknesses. The color of the interference pigment, according to the invention, can be selectively adjusted by varying the layer thickness of the dielectric layers, the optionally present semi-transparent layer and/or the layer thickness of the metallic absorptive layer. The reference numbers given in the following examples pertain to the layer structure shown as an example in FIG. 1.

Example A: Adjustment of the resultant color by variation of the dielectric layer thicknesses (2, 4) for a constant layer thickness of the semi-transparent layers (1) and (5) and a constant central absorptive layer thickness (3).

### Layer Structure Model 1:

Al(14 nm)-SiOₓ(80 nm)-Al(30 nm)-SiOₓ(80 nm)-Al(14 nm)

This layer structure is conducive to the creation of gold colored pigments. By steadily increasing the respective SiOₓ thicknesses, where x=1.95 to 2.0, from 80 nm to, say, 130 nm, a color curve from gold, violet, blue, green of the multi-layered interference pigment can be shown. Color adjustment is carried out in this case by changing the respective interference gaps created by the SiOₓ layers.

Example B: Adjustment of the desired color via the outermost layer thicknesses of the semi-transparent layers (1) and (5) for a constant dielectric layer thickness (2) and (4) and a constant central absorptive layer thickness (3).

### Layer Structure Model 2:

Al(18 nm)-SiOₓ(80 nm)-Al(30 nm)-SiOₓ(80 nm)-Al(18 nm); where x=1.95-2.0. This layer structure is conducive to the creation of gold-colored pigments. As the layer thickness of the two outermost semi-transparent Al layers steadily diminishes from 18 to 10 nm with the thickness of the other layers held constant, a color curve from gold to gold-red to violet to blue is produced.

Example C: Adjustment of the desired color based on changing to thickness of the central absorptive layer (3) for constant layer thicknesses for the outermost semi-transparent layers (1) and (5) and the intermediate dielectric layers (2) and (4).

### Layer Structure Model 3.1:

Al(11 nm)-SiOₓ(82 nm)-Al(35 nm)-SiOₓ(82 nm)-Al(11 nm); where x=1.95-2.0. This layer structure is conducive to the creation of violet pigments. A color curve from violet to violet-red to blue to green is produced by continuously reducing the thickness of the central absorptive layer from 35 to 5 nm while keeping the thickness of the other layers constant.

In this case the color change is primarily caused by the variation of the thickness of the central absorptive layer. The central absorptive layer becomes more transparent due to the decrease in thickness thereof. In this way the interference gaps of the dielectric layers can be coupled to each other.

The fact that the central metal layer becomes darker below a layer thickness of 20 nm also has a favorable effect here. As a result, a portion of the white light content of the incident light is absorbed, which in turn permits the interference colors to emerge more strongly.

### Layer Structure Model 3.2:

Al(12 nm)-SiOₓ(39 nm)-Al(35 nm)-SiOₓ(39 nm)-Al(12 nm); where x=1.95-2.0. This layer structure is conducive to the creation of silver-colored pigments, again with a constant decrease in the thickness of the central absorptive layer from 35 to 18 nm. In this case the central absorptive layer thickness, coupled with the other layer thicknesses, is almost opaque in order to avoid a stronger interference with the two intentionally very thin dielectric layers.

A color curve from gold to pink to violet is only observed at roughly 15 nm to 5 nm layer thickness of the central absorptive layer, and the influence of the transparent central absorptive layer becomes clear.

Example D: Adjustment of the desired color at a constant pigment thickness by shifting the central layer (3) accompanied by reduction or increase in the thickness of the layers (2) and (4). The layer thicknesses of the dielectric layers (2) and (4) can therefore be different.

Example E: Additionally, the choice of material for the outer semi-transparent layers and the choice of the absorptive material have a characteristic effect on the resultant color of the pigment.

The advantages of the multi-layered interference pigments according to the invention are to be seen in their shiny metallic coloring with or without color flop or with a slight shifting of the color shade, their mechanical stability and their high covering power. The high covering power results from the low pigment thickness so that per unit of weight more pigments of the invention that can contribute to coverage are present than is the case with conventional pigments having a high total thickness. Due to the optional color adjustment according to Examples A to E above, a large number of very different color series can be realized. As opposed to the pigments of the prior art, the pigments are characterized by their extremely low total pigment thickness. This permits, on the one hand, more economical production, since less starting material is used, and on the other, the production time is shortened. Finally, with a lower total pigment thickness, the covering power is improved since a larger area is covered with pigment per unit of weight thereof. In particular, in a coating with relatively thin pigments a better plane-parallel orientation accompanied by better optical properties, such as higher luster, are achieved. As elaborated above, the present invention makes it possible, depending on the selected starting materials and the degree of film thickness in each case, to produce pigments having color flop as well as pigments not having any significant color flop.

With the present invention, as opposed to the prior art, relatively long interference gaps are avoided, that is, apart from very thick dielectric layers such as SiO₂ layers having a thickness of 200 nm and more.

The colored appearance of the effect pigment can also be varied by adjusting the thickness of outer semi-transparent layers and also by changing the thickness of the central metallic absorptive layer.

Therefore, with the present invention it is possible, surprisingly, to realize color series in which the respective effective layer thicknesses of the individual layers deviate only slightly from one another. At a constant total thickness of the pigment, a large number of effect pigments with a great variety of colorings can be obtained by variation and combination of the layer thicknesses of the individual layers. These pigments may display no, or only a slight, or a distinct, color flop.

The present invention therefore enables the production of colored and metallic-luster pigments with a broad spectrum of color flops at low pigment thicknesses. The color flops may be between a weak, and a distinct, color flop. Surprisingly, the preparation of effect pigments without, or without any significant, color flop is also possible. The effect pigments of the invention therefore highly advantageously have a total thickness of preferably less than 500 nm and more preferably less than 400 nm. According to another preferred embodiment, the total thickness of the effect pigments of the invention is less than 350 nm, more preferably less than 300 nm and even more preferably less than 250 nm. The total thickness of the effect pigments of the invention is most preferably in a range of from 100 nm to 200 nm.

The central metallic absorptive layer has a geometrical layer thickness of preferably less than 35 nm and more preferably from 2 to 20 nm. Depending on the layer thickness of the metallic absorptive layer, the effect pigments of the invention have an optically high-quality metal-colored or optically high-quality gray or optically high-quality black appearance.

The aforementioned effect pigments can be attained depending on the choice of the metallic absorptive layer and its layer thickness.

Highly lustrous metallic effect pigments with their characteristic color can be prepared very well with the metals preferably used as metallic absorbers—aluminum, silver, copper or gold—and to combinations, mixtures and alloys thereof having a layer thickness of preferably about 20 to 28 nm and more preferably about 25 nm. The bilaterally flanking dielectric layers used are preferably SiO₂ layers having a thickness of preferably from 60 to 100 nm and more preferably 80 nm, in each case,.

The layer structure SiOₓ(80 nm)-Al(25 nm)-SiOₓ(80 nm), where x=1.95-2.0, produces a highly lustrous silver colored pigment. When Ag is used instead of Al, a highly lustrous silver-colored pigment is likewise produced.

The layer structure SiOx(80 nm)-Au(30 nm)-SiOₓ(80 nm) produces a highly lustrous gold-colored pigment. When Cu is used instead of Au a highly lustrous copper-colored pigment is produced.

Optically high-quality gray to black pigments can be prepared at a central absorptive layer thickness of not more than 20 nm. The PVD pigment according to the invention, in this case, has the following structure: (a) dielectric layer having a geometrical thickness of 25 nm to not more than 180 nm, (b) metallic absorptive layer having a geometrical thickness of 2 nm to 20 nm, (c) dielectric layer having a geometrical thickness of 25 nm to not more than 180 nm, said layers following each other directly, and the multi-layered PVD effect pigment has a lustrous gray to black appearance. The bilaterally flanking dielectric layers applied are preferably SiO₂ layers having a thickness of preferably 60 to 100 nm, more preferably 80 nm. The metallic absorptive layer preferably has a layer thickness of from 5 to 18 nm and more preferably from 8 to 15 nm.

Preferably no semi-transparent layers (d) and (e) are applied in the case of these gray to black effect pigments. The gray to black effect pigments preferably have only a three-layered structure of metallic absorptive layer (b) and bilaterally applied dielectric layers (a) and (c). Naturally, the gray to black pigments may also display other optically inactive protective layers.

In all cases, partially transparent metallic effect pigments are produced. Their metallic effect becomes visible, eg, in enamel applications. Here several plane-parallel layers lie one above the other and summate to form the respective metallic appearance.

The effectively low total layer thicknesses also have a positive effect on the optical behavior. It can be demonstrated by light microphotography that, above all, coarse platelets having an average particle diameter D₅₀ of 35 μm lie beside, and on top of, each other, overlapping like thin plates, plane-parallel in the applied coating. Distinct increases in luster can be achieved by the combination of a high form factor of the effect pigments of the invention with their optimal orientation in enamel applications.

The effect pigments of multi-layered structure according to the invention can be covered with other layers that have virtually no influence on the optical behavior of the aforementioned layer composition but which serve to protect from corrosion and to achieve chemical stabilization. In addition, a modifier layer of, say, phosphoric acid esters, phosphonium compounds, silanes, carboxylic acids, and other compounds may also be applied. Particularly preferred as anticorrosion agents are SiO₂ layers which surround the pigments and, in particular, completely cover the metallic fracture edges and are preferably applied by wet-chemical means. The SiO₂ layers are preferably applied by sol-gel processes. These are applied in organic solvents consisting to an extent of at least 50%, preferably at least 80%, by weight, of organic solvents. Such SiO₂-modified post-coated pigments are very preferably further surface-modified with at least one organofunctional silane. Such an organofunctional silane is capable of chemically binding the effect pigments of the invention into an enamel film. The chemical binding involves covalent bonding of effect pigment and binder system, eg, in an enamel or paint.

The application of one or more anticorrosion and/or modifying additional layers is possible both by vacuum processes and also by wet-chemical coating, wet-chemical coatings being preferred.

The diameter of the colored metal effect pigments of the invention is in the range of from 1 to 250 μm, preferably from 2 to 200 μm and more preferably from 5 to 50 μm.

The form factor, ie the ratio of pigment diameter to pigment thickness of the colored metal effect pigments of the invention is preferably between 40 and 1000 and more preferably between 100 and 400.

The high form factors due to the low layer thickness assure a very good plane-parallel orientation of the effect pigments of the invention in the application medium. Outstanding luster properties result from this and from the very smooth pigment surfaces—smooth here meaning flawless as regards optical scattering effects.

Therefore highly lustrous colored effect pigments without, or with only very slight, color flop are made available.

The object of the invention is further achieved by the provision of a method for the production of a multi-layered PVD effect pigment, which includes the following steps:
a) application of the dielectric layer (a) by PVD to a suitable support material,
b) application of the metallic absorptive layer (b) by PVD to the dielectric layer (a) applied in step (a),
c) application of the dielectric layer (c) by PVD to the metallic layer (b) applied in step (b),
d) removal of the applied layer package from the support material,
e) comminution of the layer package to a desired pigment particle size.

The object of the invention is further achieved by the provision of a method for the production of a multi-layered PVD effect pigment, which includes the following steps:
a) application of the semi-transparent layer (d) by PVD to a suitable support material,
b) application of the dielectric layer (a) by PVD to the semi-transparent layer (d) applied in step a),
c) application of the metallic absorptive layer (b) by PVD to the dielectric layer (a) applied in step b),
d) application of the dielectric layer (c) by PVD to the metallic layer (b) applied in step c),
e) application of the semi-transparent layer (e) by PVD to the dielectric layer (c) applied in step d)
f) removal of the applied layer package from the support material,
g) comminution of the layer package to a desired pigment particle size.

Preferred developments of the method of the invention are defined in the subordinate claims.

All support materials customarily used in PVD processes, such as films or fabrics, may be used as support material.

The layers determining the optical behavior are produced by modern PVD vapor deposition processes. The most recent PVD vapor deposition processes with or without a reactive gas or plasma activation, electron beam technology or resistance and radiation-heated procedures may be employed, which are described in detail in “Vakuumbeschichtung” Vol. I-V (VDI Verlag, G. Kienel ed.).

For both multi-layered interference pigments and metallic effect pigments, mechanical stability and color enhancement are possible via the optical constants, ie, the layer thickness, the vapor deposition conditions, and possible doping or secondary coating.

The object of the invention is also achieved by the use of a PVD effect pigment according to the invention in paints, enamels, coatings, printing inks, plastics, cosmetic preparations, pigment preparations, in printed securities, and bonds.

The effect pigments of the invention are preferably used in cosmetic preparations selected from the group consisting of nail polish, lipstick, make-up, hair dressings, skin care products, mascara, eye shadow, eyeliner, rouge, perfume, toilet water, powder (loose or pressed), and tattoo formulations.

The object of the invention is further achieved by the provision of a coating composition containing a PVD effect pigment. According to a preferred embodiment, the coating composition is selected from the group consisting of paints, enamels, coatings, printing inks, plastics, cosmetic preparations, preferably nail polish, and pigment preparations.

The object of the invention is further achieved by an article provided with a PVD effect pigment according to the invention or a coating composition according to the invention. The article or object may be, for example, a vehicle body, eg, an automobile body, a printed substrate, eg, paper, cardboard, wood, plastics, a film, packaging, an artificial fingernail, a passport, an identification document, a security or bond, a banknote, etc.

Despite their multi-layered structure, the pigments of the invention are extremely well oriented in the respective application system. The pigments of the invention are compatible with a large number of application systems such as, for example, enamel, printing inks, cosmetics, and plastics.

Because of their special colored metallic luster they are especially suitable for the decorative enamel sector, for the printing industry, decorative cosmetics, and the securities sector having a great variety of applications.

They may be used in the production of pigment preparations that are used especially in printing inks, enamels, and plastics materials.

The following examples and figures will explain the invention more fully without restricting it.

FIG. 1 shows the schematic structure of an effect pigment of the invention containing five layers.

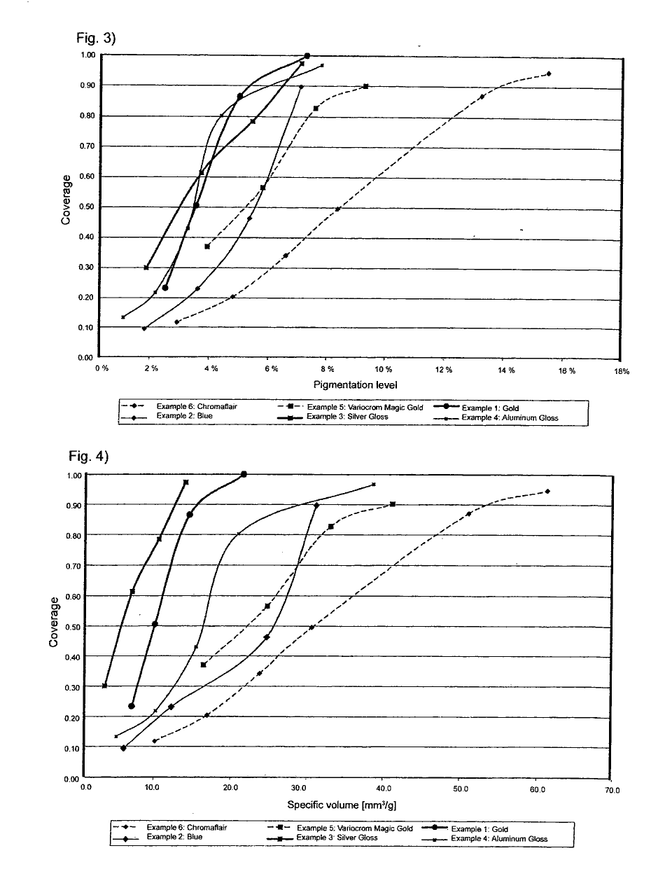

FIG. 2 shows the schematic structure of an effect pigment of the invention containing three layers.

FIG. 3 demonstrates the coverage of the pigments as a function of the pigmentation level for Examples 1 to 4 according to the invention and Comparative Examples 5 and 6.

FIG. 4 demonstrates the coverage of the pigments as a function of the specific volume for Examples 1 to 4 according to the invention and Comparative Examples 5 and 6.

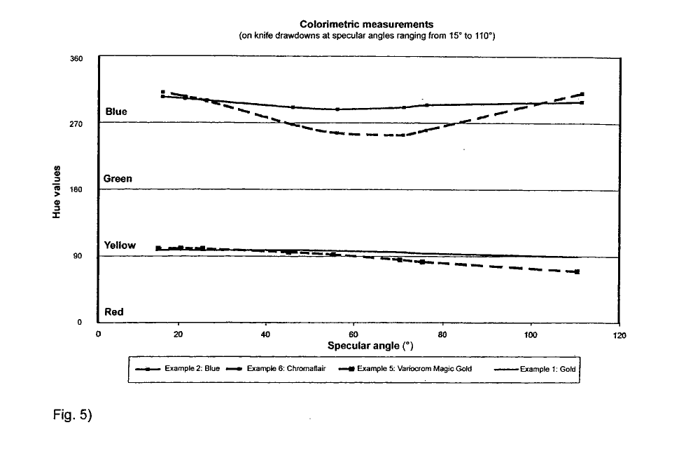

FIG. 5 shows a representation of the color flop by plotting the H* values against the angle of observation for Examples 1 and 2 according to the invention and also for Comparative Examples 5 and 6.

### EXAMPLE 1

In a laboratory PVD installation a polyethylene terephthalate (PET) film of 23 μm thickness that is coated with a release coat is coated in five passes in succession with a 1^{st} layer of silver, a 2^{nd} layer of silicon dioxide, a 3^{rd} layer of aluminum, a 4^{th} layer of silicon dioxide, and finally with a 5^{th} layer of silver.

The following geometrical layer thicknesses were applied by vapor deposition for the layers 1 to 5.

| | Substance applied by | |
|---|---|---|
| | vapor deposition | Layer thickness [nm] |
| 1^{st} Layer | Ag | 18 |
| 2^{nd} layer | SiOₓ | 70 |
| 3^{rd} layer | Al | 25 |
| 4^{th} layer | SiOₓ | 70 |
| 5^{th} layer | Ag | 18 |

x = 1.95-2.0.

The vacuum used for metallization is approx. 1·10⁻⁵ mbar. The release coat consists of acetone-soluble methyl methacrylate resin and is applied in advance in a separate working step.

On completion of the coating process, the vacuum is lifted, the metalized PET film taken out and the PET film released with acetone in a separate releasing unit. The coating is separated from the film by dissolving the release coat layer. The separated layer packages are filtered off and the filter cake formed is washed with acetone until the release coat is removed.

The washed layer packages are now comminuted in a suitable solvent to give a pigment suspension.

Gold luster pigment particles of the highest brilliance are contained in the pigment suspension. The d₅₀ value of the cumulative distribution curve of the particle size, as measured by conventional laser granulometry (Cilas 1064) according to the manufacturer's instructions, is 29.8 μm.

### EXAMPLE 2

The same procedure as in Example 1 is used in Example 2. However, the following layers are vapor deposited in their respective layer thicknesses.

| | Substance applied by | |
|---|---|---|
| | vapor deposition | Layer thickness [nm] |
| 1^{st} Layer | Al | 9 |
| 2^{nd} Layer | SiOₓ | 93 |
| 3^{rd} Layer | Al | 20 |
| 4^{th} Layer | SiOₓ | 93 |
| 5^{th} Layer | Al | 9 |

x = 1.95-2.0.

The pigment suspension obtained on completion of the treatment (as described in Example 1) contains blue-luster pigment particles of the highest brilliance. The d₅₀ value of the cumulative distribution curve of the particle size, as measured by conventional laser granulometry according to the manufacturer's instructions, is 27.8 μm.

### EXAMPLE 3

The same procedure as in Example 1 is used in Example 3. However, the following layers are vapor deposited in their respective layer thicknesses.

| | Substance applied by | |
|---|---|---|
| | vapor deposition | Layer thickness [nm] |
| 1^{st} Layer | Ag | 17 |
| 2^{nd} Layer | SiOₓ | 35 |
| 3^{rd} Layer | Ag | 17 |
| 4^{th} Layer | SiOₓ | 35 |
| 5^{th} Layer | Ag | 17 |

x = 1.95-2.0.

The pigment suspension obtained on completion of treatment (as described in Example 1) contains silver-luster pigment particles of the highest brilliance. The d₅₀ value of the cumulative distribution curve of the particle size, as measured by conventional laser granulometry according to the manufacturer's instructions, is 27.4 μm.

### EXAMPLE 4

The procedure used in Example 1 is repeated in Example 4, except that the following layers are vapor deposited with their respective layer thicknesses.

| | Substance applied by | |
|---|---|---|
| | vapor deposition | Layer thickness [nm] |
| 1^{st} Layer | SiOₓ | 82 |
| 2^{nd} Layer | Al | 22 |
| 3^{rd} Layer | SiOₓ | 82 |

x = 1.95-2.0.

The pigment suspension obtained on completion of treatment (as described in Example 1) contains silver-gray luster pigment particles of the highest brilliance. The d₅₀ value of the cumulative distribution curve of the particle size, as measured by conventional laser granulometry according to the manufacturer's instructions, is 28.6 μm.

### COMPARATIVE EXAMPLE 5

### Variocrom Magic Gold (Supplied by BASF AG)

Five-layered interference effect pigment with a core of aluminum, a bilateral SiO₂ layer and a semi-transparent iron oxide layer. The average particle size is 17 μm.

### COMPARATIVE EXAMPLE 6

### Chromaflair (Supplied by Flex Products, Inc.) Multi-layered Interference pigment produced by the PVD process. The average particle size is 19 μm.

### EXAMPLE 7

The procedure used in Example 1 is repeated in Example 7, with the exception that the following layers are vapor deposited with their respective layer thicknesses.

| | Substance applied by | |
|---|---|---|
| | vapor deposition | Layer thickness [nm] |
| 1^{st} Layer | Al | 12 |
| 2^{nd} Layer | SiOₓ | 58 |
| 3^{rd} Layer | Al | 36 |
| 4^{th} Layer | SiOₓ | 58 |
| 5^{th} Layer | Al | 12 |

x = 1.95-2.0.

The pigment suspension obtained on completion of treatment (as described in Example 1) contains multi-colored shimmering pigment particles of the highest brilliance. The d₅₀ value of the cumulative distribution curve of the particle size, as measured by conventional laser granulometry according to the manufacturer's instructions, is 27 μm.

### COMPARATIVE EXAMPLE 8

The procedure used in Example 1 is repeated in Comparative Example 8, with the exception that the following layers are vapor deposited with their respective layer thicknesses.

| | Substance applied by | |
|---|---|---|
| | vapor deposition | Layer thickness [nm] |
| 1^{st} Layer | Al | 12 |
| 2^{nd} Layer | SiOₓ | 58 |
| 3^{rd} Layer | Al | 62 |
| 4^{th} Layer | SiOₓ | 58 |
| 5th Layer | Al | 12 |

x = 1.95-2.0.

The pigment suspension obtained on completion of treatment (as described in Example 1) contains silver-colored shimmering pigment particles. The d₅₀ value of the cumulative distribution curve of the particle size, as measured by conventional laser granulometry according to the manufacturer's instructions, is 27.9 μm.

No commercially available three-layered interference pigments are known at present which could have been used for comparison.

### Coverage Comparison:

The respective pigment was stirred at different pigmentation levels (percentage by weight of pigment, based on the total weight of the wet enamel) ranging from 1 to 16% by weight into 2 g of a conventional nitrocellulose enamel (Dr. Renger Erco Bronzemischlack 2615e, supplied by Morton Co.), the effect pigment being placed on a substrate and subsequently dispersed in the enamel with a paintbrush.

The finished enamel was applied by doctor blade to test cards No. 2853 by the Byk Gardner Co. (contrast paper) to give a wet film thickness of 50 μm thereon.

At all pigmentation levels the enamel applications were measured on black and white background with a goniospectrophotometer supplied by the Optronic Multiflash Co., Berlin, Germany, at a measurement angle of 110° relative to the specular angle according to the manufacturer's information.

The quotient of the brightness values from black to white background was plotted against the pigmentation level in % by weight and is given in FIG. 3. To achieve better comparability of the pigments to allow for their different densities, the weighed quantities of the pigments were converted to pigment volumes, from which the specific volume of pigment per gram of enamel was calculated in each case, as shown in FIG. 4.

A value greater than 0.98 is normally used as coverage criterion for aluminum pigments in the literature, as mentioned, for example, in EP 0 451 785. However, because of their relatively low metal content, multi-coated effect pigments of the prior art naturally display poorer coverage than pure aluminum pigments. Thus, a quotient of 0.9 upwards may be regarded as good coverage for this type of effect pigments.

As shown in FIG. 3 and FIG. 4, the pigments of the invention of Examples 1 to 4 display a clearly better coverage than the pigments of Comparative Examples 5 and 6. The clearly better coverage properties of the pigments of Examples 1 to 4 according to the invention are traceable to their low total thickness. The pigments of Examples 1 to 4 according to the invention have effective total thicknesses ranging from 130 to 225 nm. The pigments in Comparative Examples 5 and 6 have effective total thicknesses of approx. 1 μm. The form factors of the pigments of the invention of Examples 1 to 4 range from 124 to 226 nm. The pigments of the Comparative Examples 5 and 6 have form factors of less than 20. Such a low form factor is accompanied by poor orientation in the application medium, leading to lower coverage and also to lower luster scores.

TABLE 1
Colorimetric properties and covering capacity parameters at L* = 110°,
white/L* 110°, black = 0.9 in an overview.

| | | Covering capacity | | | | |
|---|---|---|---|---|---|---|
| | | Pigmentation | | | | |
| | | level* at | | | | |
| | Median | coverage | Specific | colorimetrics, coloristics | | |
| | value | quotient >0.9 | volume* | Luster | Luster | Subjective |
| Sample | d₅₀ [μm] | [% w/w] | [mm³/g] | 60°* | 20°* | impression |
| Example 1 of | 29.8 | 4.8 | 13.7 | 133 | 52 | gold lustrous |
| invention | | | | | | knife drawdown |
| | | | | | | without color |
| | | | | | | flop |
| Example 2 of | 27.8 | 6.9 | 30.3 | 28 | 6 | gold lustrous |
| invention | | | | | | knife drawdown |
| | | | | | | without |
| | | | | | | significant color |
| | | | | | | flop |
| Example 3 of | 27.4 | 6.9 | 16.3 | 147 | 61 | highly lustrous |
| invention | | | | | | silver colored |
| | | | | | | knife drawdown |
| Example 4 of | 28.6 | 4.2 | 20.1 | 129 | 47.2 | silver colored |
| invention | | | | | | lustrous knife |
| | | | | | | drawdown |
| Comp. Example | 17 | 9.1 | 34.8 | 11 | 5 | knife drawdown |
| 5 (Variocrom | | | | | | with strong color |
| Magic Gold) | | | | | | flop from gold |
| | | | | | | yellow shifting to |
| | | | | | | rust brown |
| Comp. Example | 19 | 13.9 | 54.1 | 8 | 2 | knife drawdown |
| 6 (Chromaflair) | | | | | | with strong color |
| | | | | | | flop shifting from |
| | | | | | | blue to green to |
| | | | | | | violet |
| Example 7 of | 27 | 5.2 | 23.9 | 135 | 53 | knife drawdown |
| invention | | | | | | with strong color |
| | | | | | | flop shifting from |
| | | | | | | violet to gold |
| | | | | | | green |
| Comp. Example 8 | 27.9 | 6.1 | 28.2 | 140 | 57 | knife drawdown |
| | | | | | | without signifycant |
| | | | | | | color flop |
| | | | | | | with silver |
| | | | | | | appearance |

Comparison of Example 7 of the invention with Comparative Example 8 clearly shows the effect of the semi-transparent central absorptive layer. In Example 7 a pigment with a distinct color flop is obtained since the lower SiOₓ/Al layers are also able to contribute to the color impression due to the partial transparency of the central Al layer. In Comparative Example 8, conversely, the central Al layer is opaque and the low layer thickness of 58 nm of the SiOₓ layer is not sufficient to achieve interference effects.

### Colorimetric Properties:

For comparison of the calorimetric properties use is made of the nitrolack applications described in Table 1 “Coverage comparison.” For this purpose applications with the pigmentation levels listed in Table 1 on a black background were used. The measurement was performed using a goniospectrophotometer supplied by the Optronic Multiflash Co., Berlin, according to the manufacturer's instructions. At a constant incidence angle of 45° measurements were performed at eight different angles relative to the gloss angle. The measurement angles were: 15°, 20°, 25°, 45°, 55°, 70°, 75° and 110°. Far from all color effects of effect pigments can be measured using such measurement geometry. In particular, interference pigments and interference effects are not very well detectable with such measurement geometry (cf. also W. R. Cramer and P. W. Gabel, farbe+lack 109 (2003)78). That means that the subjective impression of the viewer is only approximately reproduced by such readings.

In FIG. 5, the H* values (chromaticity point, hue) of all Examples 1 to 4 of the invention and of Comparative Examples 5 and 6 from the L*C*H* system are plotted against the angle of observation. A slight color shift is observed for the pigments of Example 2 of the invention, while the pigments of Example 1 display no color shift over the entire effect angle range.

The pigments of Comparative Example 6 have a distinct color flop, in which the chromaticity point varies over a broad range of the difference angle.

As can be seen from Table 1, the pigments according to Comparative Example 5 display a color shift from gold-yellow to rust-brown.

Compared with the pigment of the invention of Example 1 this does not represent an attractive color shift. Furthermore, the pigment used in Comparative Example 5 displays a total pigment thickness of clearly 800 nm.

Example 9 according to the invention

As in Example 1, a five-layered effect pigment was prepared having the following layer structure:

| | Al | SiOₓ | Al | SiOₓ | Al |
|---|---|---|---|---|---|
| Layer | 9 | 82 | 21 | 82 | 9 |
| thicknesses | | | | | |
| [nm] | | | | | |

x = 1.95-2.0.

Example 10 of the invention

As in Example 1, a three-layered effect pigment was prepared with the following layer structure:

| | SiOₓ | Al | SiOₓ |
|---|---|---|---|
| Layer | 82 | 15 | 82 |
| thicknesses | | | |
| [nm] | | | |

x = 1.95-2.0.

The effect pigments of Examples 9 and 10 according to the invention were stirred into a nail polish to give a pigmentation of 1% by weight. The nail polish had the following composition:

| | Concentration |
|---|---|
| | in % by |
| Substance | weight |
| Nitrocellulose | 15 |
| Ethyl acetate | 21.15 |
| n-Butyl acetate | 39 |
| Isopropyl alcohol | 8 |
| Polyester binder | 9 |
| Dibutyl phthalate | 5 |
| Camphor | 2.0 |
| Stearalkonium bentonite | 0.85 |
| Pigments per invention Examples 9 | 1.0 |
| and 10 | |

The nail polish containing the pigments according to Example 9 of the invention, after application to real or artificial fingernails, has a color-intense brilliant gold appearance.

The nail polish containing the pigments according to Example 10 of the invention, after application to real or artificial fingernails, has a steel-gray highly lustrous appearance.

Both nail polish applications showed a highly lustrous metallic color shade resembling a “liquid metal”, ie visually the nail polish appears to be a continuous phase in which the individual pigment particles are not visible.

The present invention therefore produces colored effect pigments with a metallic luster.

The advantage of the pigment of the invention is, on the one hand, its metal-like lustrous chromaticity and its coverage, ie its high covering power. Its chromaticity, based on interference and reflection/transmission properties, is not impaired by significant color hue shifts. It is possible to produce pigments with and without a color flop over a broad spectrum of colors while keeping the total thickness of the pigment very low. Since all involved layers contribute colors in their respective layer thicknesses, a multifarious color design is possible, surprisingly, at very low effective pigment thicknesses.

The layers determining the optical behavior are produced by modern PVD vapor deposition processes. During pigment production, the layer structure produced in the vapor deposition process is comminuted. The application of one or more additional anticorrosion and/or modifying layers is possible both by vacuum processes and by wet-chemical coating.

1) A multilayered PVD effect pigment, wherein said multi-layered PVD effect pigment comprises the following layer sequence:
(a) a dielectric layer having a geometrical thickness of from 25 nm to not more than 180 nm,
(b) a metallic absorptive layer having a geometrical thickness of not more than 35 nm,
(c) a dielectric layer having a geometrical thickness of from 25 nm to not more than 180 nm,
wherein the layers adjoin each other directly and the dielectric layers (a) and (c) are the same or different.

2) The multilayered PVD effect pigment as defined in claim 1, wherein said metallic absorptive layer has a geometrical thickness of not more than 30 nm and preferably of from 2 nm to 20 nm.

3) The multilayered PVD effect pigment as defined in claim 1, wherein said dielectric layers (a) and (c) have a geometrical thickness of not more than 150 nm in each case.

4) The multilayered PVD effect pigment as defined in claim 1, wherein said dielectric layers (a) and (c) have a geometrical thickness ranging, in each case, from 30 nm to not more than 100 nm.

5) The multilayered PVD effect pigment as defined in any claim 1, wherein the metal layer comprises or consists of metals selected from the group consisting of aluminum, silver, copper, gold, chromium, iron, titanium, platinum, palladium, nickel, cobalt, niobium, tin, zinc, rhodium, mixtures thereof, and alloys and combinations thereof.

6) The multilayered PVD effect pigment as defined in claim 1, wherein the dielectric material is selected from the group consisting of metal fluorides, metal oxides, metal sulfides, metal nitrides, metal carbides, and mixtures and combinations thereof.

7) The multilayered PVD effect pigment as defined in claim 1, wherein the dielectric material is selected from the group consisting of SiO₂, SiOₓ, where x is from 1.5 to 2, Al₂O₃, B₂O₃, TiO₂, ZrO₂, MgF₂, and mixtures and combinations thereof.

8) The multilayered PVD effect pigment as defined in claim 1, wherein said multilayered PVD effect pigment has the following layer sequence:
(d) a semi-transparent layer,
(a) a dielectric layer,
(b) a metallic absorptive layer,
(c) a dielectric layer, and
(d) semi-transparent layer,
where the semi-transparent layers (d) and (e) are directly applied to the dielectric layers (a) and (c) and are the same or different.

9) The multilayered PVD effect pigment as defined in claim 8, wherein said semi-transparent layers (d) and (e) consist of a material having a refractive index in the optical region of more than 2.2 and/or of a metal.

10) The multilayered PVD effect pigment as defined in claim 9, wherein said semi-transparent layers (d) and (e) comprise or consist of metals selected from the group consisting of aluminum, silver, copper, gold, chromium, iron, titanium, platinum, palladium, nickel, cobalt, niobium, tin, zinc, rhodium, mixtures thereof, and alloys and combinations thereof.

11) The multilayered PVD effect pigment as defined in claim 1, wherein said multilayered PVD effect pigment comprises the following layer sequence:
(a) a dielectric layer having a geometrical thickness of from 25 nm to not more than 180 nm,
(b) a metallic absorptive layer having a geometrical thickness of from 2 run to 20 nm,
(c) a dielectric layer having a geometrical thickness of from 25 nm to not more than 180 nm,
where the layers adjoin each other directly and the multilayered PVD effect pigment has a lustrous gray to black appearance.

12) The multilayered PVD effect pigment as defined in claim 1, wherein said multilayered PVD effect pigment is provided with an enveloping anti-corrosive layer and/or inhibitory layer, which preferably also completely covers the metallic break edges.

13) The multilayered PVD effect pigment as defined in claim 1, wherein said multilayered PVD effect pigment is provided with an enveloping anti-corrosive layer consisting of a SiO₂ layer applied by a chemical wet-process, which preferably also covers the metallic break edges completely.

14) The multilayered PVD effect pigment as defined in claim 13, wherein said SiO₂ layer is organochemically surface-modified, preferably with at least one silane.

15) A method for the production of a multilayered PVD effect pigment as defined in claim 1, wherein it comprises the following steps:
(a) application of a dielectric layer (a) by PVD on a suitable support material,
(b) application of the metallic absorptive layer (b) by PVD to the dielectric layer (a) applied in step (a),
(c) application of the dielectric layer (c) by PVD to the metal layer (b) applied in step (b),
(d) removal of the applied layer package from the support material,
(e) comminution of the layer packages to a desired pigment particle size.

16) A method for the production of a multilayered PVD effect pigment as defined in claim 8, wherein it comprises the following steps:
a) application of the semi-transparent layer (d) by PVD to a suitable support material,
b) application of the dielectric layer (a) by PVD to the semi-transparent layer (d) applied in step a),
c) application of the metallic absorptive layer (b) by PVD to the dielectric layer (a) applied in step b),
d) application of the dielectric layer (c) by PVD to the metal layer (b) applied in step c),
e) application of the semi-transparent layer (e) by PVD to the dielectric layer (c) applied in step d)
f) removal of the applied layer package from the support material,
g) comminution of the layer packages to a desired pigment particle size.

17) The method as defined in claim 15 wherein the pigment particles obtained following comminution are provided, via a chemical wet-process, with an SiO₂ layer.

18) The method as defined in claim 17, wherein the SiO₂ coating is surface-modified organochemically, preferably with at least one silane.

19) The use of a PVD effect pigment as defined in claim 1 in paints, varnishes, coatings, printing inks, plastics materials, cosmetic preparations, pigment preparations, in security printing, or bond printing.

20) The use as defined in claim 19, wherein said cosmetic preparations are selected from the group consisting of nail varnish, lipstick, make-up, hair-care preparations, skin-care preparations, mascara, eye-shadow, eyeliner, rouge, perfume, toilet water, powder (loose or compressed), and tattooing formulations.

21) A coating composition, wherein the coating composition contains a PVD effect pigment as defined in claim 1.

22) The coating composition as defined in claim 21, wherein the coating composition is selected from the group consisting of paints, varnishes, coatings, printing inks, plastics materials, cosmetic preparations, preferably nail varnish, and pigment preparations.

23) An object, wherein it is provided with a PVD effect pigment as defined in claim 1.

24) A method for the production of a multilayered PVD effect pigment as defined in claim 11, wherein it comprises the following steps:
(a) application of a dielectric layer (a) by PVD on a suitable support material,
(b) application of the metallic absorptive layer (b) by PVD to the dielectric layer (a) applied in step (a),
(c) application of the dielectric layer (c) by PVD to the metal layer (b) applied in step (b),
(d) removal of the applied layer package from the support material,
(e) comminution of the layer packages to a desired pigment particle size.

25) The method as defined in claim 16 wherein the pigment particles obtained following comminution are provided, via a chemical wet-process, with an SiO₂ layer.

26) An object, wherein provided a coating composition as defined in claim 21.
